(19) United States
(12) Patent Application Publication
(10) Pub. No.: US 2017/0105429 A1
(43) Pub. Date: Apr. 20, 2017

(54) PET FOOD CAPABLE OF REMOVING DENTAL CALCULUS AND PLAQUE AND METHOD FOR MANUFACTURING SAME

(71) Applicant: FORCANS INC., Gyeonggi-do (KR)

(72) Inventor: Bon Gil KOO, Gyeonggi-do (KR)

(73) Assignee: FORCANS INC., Gyeonggi-do (KR)

(21) Appl. No.: 15/310,967

(22) PCT Filed: May 18, 2015
(86) PCT No.: PCT/KR2015/004960

§ 371 Date: Nov. 14, 2016

(30) Foreign Application Priority Data
May 19, 2014 (KR) 10-2014-0059920

(51) Int. Cl. A23K 40/20; A23K 20/163; A23K 50/40; A23K 40/30

(52) U.S. Cl. CPC A23K 40/20; A23K 40/30; A23K 20/163; A23K 50/40

(57) ABSTRACT

Provided is a pet food for easily removing dental calculus and plaque from teeth and gums of a pet by inducing active masticatory action of the pet. In the pet food, through-holes having various sectional shapes are formed at regular or irregular intervals through a body that is edible by the pet. Wrinkled portions (or screw threads) are longitudinally or transversely formed in the inner circumferential surface of the through-hole. Alternatively, one or more protrusion units protrude toward the longitudinal central axis of the through-hole from the inner circumferential surface of the through-hole, or protrude from the inner circumferential surface of the through hole so as to form a helical ridge.

### TECHNICAL FIELD

### CROSS-REFERENCE TO RELATED APPLICATION

This application claims priority and the benefit of Korean Patent Application No. 10-2014-0059920 filed in the Korean Intellectual Property Office on May 19, 2014, the entire contents of which are incorporated herein by reference.

The present invention relates to a pet food capable of removing dental calculus and plaque, and a method of manufacturing the same.

### BACKGROUND ART

Recently, in addition to feeding, interest in the healthcare of pets has increased in accordance with a continuous increase in the number of persons keeping pets. However, it is very cumbersome to periodically and continuously feed pets, and accordingly, pet foods have been developed so as to have shapes suitable for stimulating pets' curiosity to thus induce a masticatory action. Further, as the number of people who travel increases, pet owners frequently bring pets along when traveling or camping. Accordingly, there is a demand for simple meal substitution foods for pets.

With regard thereto, US Patent Publication No. 2008-0314333 suggests a bone-shaped structure including an elastic elastomer material, which interests dogs, among pets, so as to satisfy the aforementioned requirements. A food receiving unit is formed in the body of the bone-shaped structure, and edible pet foods are inserted into the food receiving unit, so that a pet's interest in the bone-shaped structure is increased to thus allow the pets to eat while playing.

However, the bone-shaped structure includes the elastic elastomer material, which is not edible. Accordingly, there are problems in that the bone-shaped structure must be kept clean when reused, and that the pet may be endangered, that is, the pet may have indigestion or may be killed, if the bone-shaped structure is broken into small pieces by the sharp teeth of the pet and the pet swallows the pieces.

Further, it is very important in terms of health care to remove dental calculus covering the teeth after the masticatory action of the pet, but this is not considered in the aforementioned patent document.

Plaque discolors all of the teeth of the pet, and accumulates and hardens to form dental calculus in the vicinity of the gums, thus spoiling the appearance of the teeth and causing gum diseases or, ultimately, the loss of teeth. Accordingly, a pet owner has to make efforts to care for the teeth and oral cavity of the pet, such as rinsing the mouth after feeding.

Therefore, teeth scaling is usually performed at a veterinary clinic in order to remove plaque and dental calculus. However, charges for such veterinary treatment are high, and the need has arisen to take care of pets' teeth more easily. Accordingly, solutions including a wide variety of chemical and biological medicines have been proposed in order to delay the formation of dental calculus, to remove formed dental calculus, or to reduce the amount of dental calculus that is formed.

One of the solutions is to provide a hard chewing gum to pets so as to mechanically remove the dental calculus and the plaque covering the teeth.

For example, Korean Patent No. 10-1009987, which was submitted by the applicant of the present invention and for which a patent was then granted, discloses a dental gum for removing plaque and dental calculus attached to pet's teeth in order to manufacture foods including bodies made of edible materials and to improve the health of pets' teeth, thereby reducing a pet owner's trouble to take care of the pet's teeth after feeding, given that the sanitary control of known foods including inedible materials is a high-maintenance and time-consuming job.

However, in the case of pets' teeth, the upper and lower jaws are different from each other and the tooth arrangement is irregular in front and tear parts, unlike human teeth. Accordingly, there is a demand for a structure which allows pets' teeth to be to easily inserted into the holes therein and comes into contact with an entire tooth trunk, thereby removing the plaque and the dental calculus.

### DISCLOSURE

### Technical Problem

Accordingly, the present invention has been made keeping in mind the above problems occurring in the related art, and an object of the present invention is to provide a pet food which is used for the purpose of a meal or meal substitution, easily removes plaque and dental calculus formed on a pet's tooth trunk having various sizes and shapes, and has a shape suitable for performing scaling.

### Technical Solution

Therefore, the present invention discloses at least the following aspects.

[1]. In order to accomplish the above object, the present invention provides a pet food capable of removing dental calculus and plaque, the pet food including a bar-type body through which at least one through-hole is transversely formed so as to be arranged along the longitudinal direction of the body. A tooth trunk of a pet enters the through-hole during a masticatory action of the pet to come into contact with the inner circumferential surface of the through-hole.

[2]. In [1], the through-hole includes one or more protrusion units which protrude toward a longitudinal central axis of the through-hole from the inner circumferential surface of the through-hole, or which protrude from the inner circumferential surface of the through-hole so as to form a helical ridge.

[3]. In [1], a screw thread is longitudinally or transversely formed in the inner circumferential surface of the through-hole.

[4]. In [2], a screw thread is longitudinally or transversely formed in the inner circumferential surface of the through-hole and in lateral surfaces of the protrusion units extending from the inner circumferential surface.

[5], In [2], the through-hole including the protrusion units has the sectional shape of a circle, a polygon, or the leaves of a three-leaf clover.

[6], In [1], the total area of the sections of the through-holes formed through the body is more than 40% of the total surface area of the entire Upper surface and the entire lower surface of the body.

[7]. In [6], the through-hole has a sectional shape of a circle, a semi-circle, an oval, a polygon, a pentagram, a cogwheel, a dumbbell, or a cloud including two or more circles or ovals that partially overlap.

[8]. In [7], the through-holes formed through a body have an identical sectional shape or different sectional shapes.

[9]. In [1], the body may include a coating layer having surface strength that is equal to or higher than the strength of the body.

[10]. In [9], the body may include a humectant layer disposed beneath the coating layer.

[11]. In [1], one or more rows of through-holes are longitudinally and transversely arranged in the body.

[12]. In [11], a small-diameter through-hole, smaller than the through-hole, is formed between the rows of the through-holes.

[13]. In order to accomplish the above object, the present invention also provides a method of manufacturing a pet food, the method including providing 100 wt % of a mixture including 30 to 70 wt % of a starch, 5 to 30 wt % of a sugar, and the balance of solvent mixed therein, and molding the mixture so that the mixture has a bar-type body through which at least one through-hole is transversely formed to be arranged along the longitudinal direction of the body, and so that a tooth trunk of a pot enters the through-hole during a masticatory action of the pet to come into contact with the inner circumferential surface of the through-hole.

[14]. In [13], the method further includes longitudinally or transversely forming a screw thread in the inner circumferential surface of the through-hole.

[15]. In [13], the method further includes forming protrusion units which protrude toward a longitudinal central axis of the through-hole from the inner circumferential surface of the through-hole, or which protrude from the inner circumferential surface of the through-hole so as to form a helical ridge.

[16]. In [13], the method further includes applying a coating layer, a humectant layer, or both a coating layer and a humectant layer on the body.

[17]. In [13], the method further includes forming the through-holes having the same sectional shape or two or more different sectional shapes through the body.

[18]. In [13], the molding the mixture includes an injection-molding process.

[19]. In [13], the coating layer further includes a palatability enhancer, an antimicrobial agent, a flavoring agent, or a coloring agent.

### Advantageous Effects

According to a simple structural characteristic of a pet food of the present invention and a method of manufacturing the same, the contact area between the body of the pet food and a pet's tooth trunk is increased during the masticatory action of a pet eating the food or snack, thus performing scaling and easily removing dental calculus and plaque. Thereby, it is possible to easily maintain the health of the pet's teeth and gums.

Further, it is possible to save a pet owner's trouble in taking care of the teeth and gums of the pet.

### DESCRIPTION OF DRAWINGS

FIG. 1a is a perspective view of a pet food, through which through-holes arc formed and which is used to remove dental calculus and plaque, according to an embodiment of the present invention;

FIG. 1b is a sectional view of the pet food, which is taken along the line A-A′ of FIG. 1a;

FIG. 1c is a sectional view of the pet food of FIG. 1a, which is covered with a humectant layer and then with a coating layer, according to another embodiment of the present invention;

FIG. 2a is a perspective view of a pet food, through which through-holes are formed and which includes screw threads longitudinally formed in the inner circumferential surfaces of the through-holes to remove dental calculus and plaque, according to another embodiment of the present invention;

FIG. 2b is a sectional view of the pet food, which is taken along, the line B-B′ of FIG. 2a;

FIG. 3a is a perspective view of a pet food, through which through-holes having the sectional shape of a cogwheel are formed to remove dental calculus and plaque, according to another embodiment of the present invention;

FIG. 3b is a sectional view of the pet food, which is taken along the line C-C′ of FIG. 3a;

FIG. 4a is a plan view of a pet food including through-holes, which have a rectangular section and are formed in a 2×6 row arrangement, and four protrusion units, which protrude from the inner circumferential surface of each through-hole, according to another embodiment of the present invention;

FIG. 4b is a plan view of a pet food including through-holes, which have a circular section and are formed in a 2×6 row arrangement, five protrusion units, which protrude from the inner circumferential surface of each through-hole, and a small-diameter through-hole, which is formed between the rows, according to another embodiment of the present invention;

FIG. 4c is a plan view of a pet food, which has almost the same constitution as the pet food of FIG. 4b but which is different from that of FIG. 4b in that a 3×6 row constitution is adopted in FIG. 4c;

FIG. 4d is a plan view of a pet food including through-holes having various sectional shapes according to another embodiment of the present invention; and

FIG. 5 is a plan view of a pet food capable of removing dental calculus and plaque according to another embodiment of the present invention, the pet food including through-holes having a rectangular section, protrusion units, which have the sectional shape of a three-leaf clover, which protrude toward the longitudinal central axis of the through-hole from the inner circumferential surface of the through-hole having the rectangular section or which obliquely protrude from the inner circumferential surface, and a groove, which is formed in the lateral surface of the protrusion unit and which is enlarged in a perspective view indicated by a dotted circle.

### MODE FOR INVENTION

The present invention will be described below in greater detail with reference to the drawings. The drawings are provided to illustrate particularly preferable embodiments of the present invention, and the present invention should not be construed as limited to the embodiments shown therein.

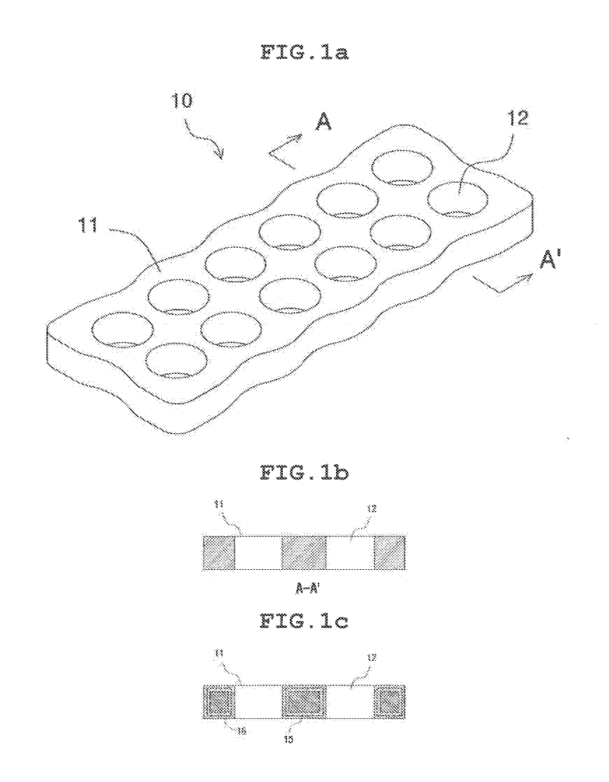

FIG. 1a is a perspective view of a pet food 10 according to an embodiment of the present invention. The food 10 has a bar-type body 11, and one or more through holes 12 are formed through the body, which has a hardness of 15 to 50 A (measured by a durometer). The through-holes are formed through upper and lower sides of the body so that the teeth of a pet are easily inserted into the through-holes during the masticatory action of the pet, thus enabling the trunk of the tooth to come into physical contact with the inner circumferential surface of the through-hole. Accordingly, dental calculus and plaque may be removed only through the masticatory action of the pet, thereby preventing diseases of the teeth, gums, and/or mouth and ultimately maintaining the pet's health in good condition.

The body 11 according to the embodiment of the present invention includes 100 wt % of a mixture including 30 to 70 wt % of starch, 5 to 30 wt % of sugar, and the balance of solvent mixed therein, and has a water content of 10 to 14% so as to come into contact with the teeth with a predetermined contact force.

The starch according to the embodiment of the present invention may be obtained from one or more selected from corn, potato, sweet potato, tapioca, wheat, gluten, rice, oat, soybean, and barley. However, when the amount of starch that is used is less than 30 wt %, binding force may be too weak to provide physical contact force, and when the amount is more than 70 wt %, binding force and hardness may be slightly high, thus injuring the teeth or gums.

The sugar according to the embodiment of the present invention provides appropriate binding force, molding stability, and sweetness to the body of the food, and the sweetness may be used to enhance the digestibility in an intestinal digestive system. Further, the sugar includes one or more selected from isomalto-fructo-oligosaccharides, galacto-oligosaccharides, soy-oligosaccharides, maltitol, sorbitol, mannitol, lactitol, erythritol, and malto-oligosaccharides. When the sugar is used in a content of less than 5 wt %, the molding binding force and the molding stability of the body 11 are reduced, and when the content is more than 30 wt %, the water content is increased, thus reducing the hardness.

In consideration of this, the components according to the embodiment of the present invention may be mixed well with the solvent and then molded to manufacture a molded article (that is, the body) having a predetermined shape. Heating using hot wind at 30 to 90° C. and cooling may be appropriately repeated until a predetermined hardness is obtained, whereby the molded article is dried. A natural drying process may be adopted if necessary. The hardness of the body that is manufactured according to the aforementioned procedure is preferably 15 to 50 A so as to remove the dental calculus and the plaque and to maintain bendability, elasticity, and rigidity.

When the hardness of the molded article is less than 15 A, the physical frictional force applied to the teeth is too weak to effectively remove the plaque and the dental calculus. When the hardness is more than 50 A, the molded article may be excessively hardened and thus negatively affect the teeth and digestion and/or injure the teeth or gums.

Examples of other optional components may include one or more humectants selected from the group consisting of palm oil, olive oil, soybean oil, corn oil, rapeseed oil, rice kernel oil, grapeseed oil, sunflower oil, hydrogenated palm kernel oil, propylene glycol, glycerin, aloe vera, sorbitol, and glucose. The optional component is used to impart better elasticity and flexibility to the body of the present invention so that the body is not easily broken and the tissue thereof is made soft, and is also used to improve the moisturizing ability and the intestinal digestibility.

Further, in order to improve the palatability and the functionality of the pet food of the present invention, one or more additives of a palatability enhancer, a dental calculus remover, a nutrient, a binder, and an antimicrobial agent may be used to manufacture the body so that the additive is included in the body within the content range applicable to the related art.

Examples of the palatability enhancer may include beef, pork, mutton, poultry, egg yolk, whole egg, egg white, MDCM (mechanically deboned chicken meat), or a combination thereof, but are not limited thereto.

Further, examples of the dental calculus remover for helping dental calculus removal, dental deposition prevention, and relief of inflammatory disorders may include zinc salts or phosphates. Examples of the zinc salts include zinc nitrates, zinc sulfates, zinc citrates, zinc chlorides, zinc acetates, or zinc gluconates, and examples of the phosphates include polyphosphates such as pyrophosphates, tripolyphosphates, hexametaphosphates, and combinations thereof. One or more of the aforementioned examples may be selected and used.

According to the embodiment of the invention, vitamins, such as B-group vitamins, and nutrient components, such as calcium gluconates, may be added so as to provide nutrients to the teeth and the oral mucosa. One or more of grapefruit seed extract, acetic acid, dibenzoyl thiamine, lactic acid, malic acid, adipic acid, phytic acid, chito-oligosaccharides, chitosan, and green tea extract, or a compound including two or more thereof may be used for the purpose of achieving anti-inflammatory and antibacterial actions.

One or more may be selected from among gelatine, xanthan gum, sodium carboxymethyl cellulose, carrageenan, agar, alginic acid, and methyl cellulose to be used as the binder component. An edible coloring agent or an edible flavoring agent may be added so as to improve the appearance and flavor of the final product.

Preferably, the total sectional area of the upper and lower sides of the through-holes 12 formed through the molded body 11 is more than 40% of the total surface area of the upper and lower surfaces of the body 11 (that is, the surface area before the through-holes are formed) so that various shapes of pets' teeth, which protrude irregularly, are capable of being inserted into the through-holes. Accordingly, the through-holes 11 may be formed through the upper and lower parts of the body 11, for example, in an arrangement of 2×6, 3×6, 3×5, or 2×7 rows. The intervals between the through-holes constituting the rows may be the same or different, and the through-holes may be formed at regular or irregular intervals. A small-diameter through-hole smaller than the through-hole 12 may be formed between the rows.

FIG. 1a shows the through-hole 12 having a circular section. However, the sectional shape may be a polygon, an oval, a semi-circle, a pentagram, a cogwheel, a three-leaf clover, or a cloud (a shape including two or more circles or ovals that partially overlap) in order to increase the scaling, dental calculus, and plaque removal efficiency.

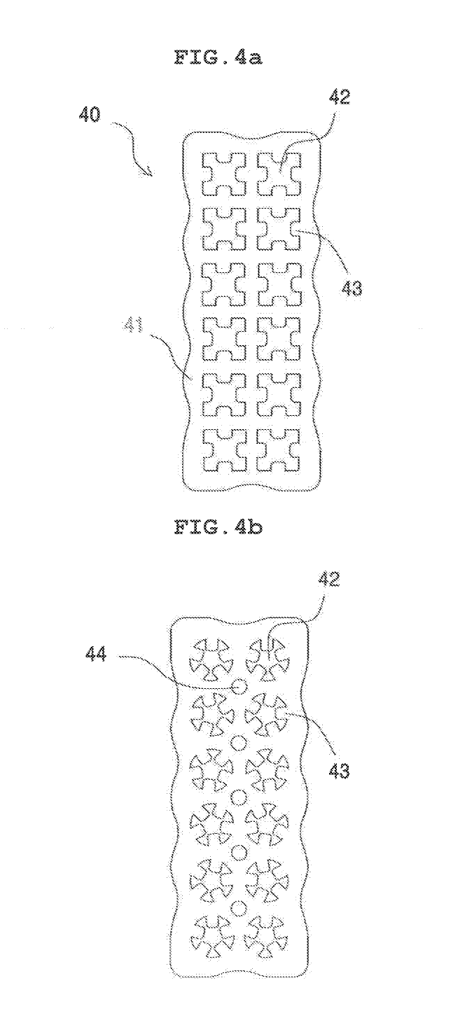

Further, through-holes having only one sectional shape among the aforementioned sectional shapes may be formed through the body 11 (a circle is selected in FIG. 1a). However, in some cases, as shown in FIG. 4d, through-holes having two or more different sectional shapes may be formed through the body. From FIG. 4d, it can be seen that the protrusion unit protruding from the inner circumferential surface of the through-hole is omitted in order to clarify the drawing.

A typical pet food inevitably breaks down and ages upon long-term storage. Accordingly, a coating solution and/or a humectant may be applied on the external surface of the body of the food (FIG. 1c) so as to increase the shelf life of the pet food, to protect effective nutrient components, and to provide predetermined contact force (frictional force) when the teeth come into contact with the body. The humectant may be mixed with the material of the body in advance so as to simplify the process.

The coating solution includes 3 to 20 wt % of a coating agent and a solvent (preferably water). Examples of the coating agent that is used may include one or more selected from gelatin, xanthan gum, sodium carboxymethyl cellulose, carrageenan, agar, alginic acid, and methyl cellulose. Gelatin, when used as the coating agent, is a low-calorie food material and is a protein made by the partial hydrolysis of collagen, which is the protein of animal connective tissue. The coating agent is powder having a smell and taste similar to those of the juices that come from meat, and is used to perform surface coating, thus preventing various foods from absorbing water and also from drying. When the amount (dilution amount) of the coating agent that is used is less than 0.5 wt %, the coating solution is very dilute, thus excessively increasing the coating time. When the amount is more than 20 wt %, since the concentration of the coating solution is very high, the distribution of the coating solution is not uniform on the coated surface, the workability becomes poor, and the quality of the product is reduced due to hardening of the coating solution.

Examples of the coating method according to the embodiment of the present invention may include a spray method and a dipping method. With regard to the spray method, the coating solution is constantly sprayed through a nozzle, and there is a merit in that the surface is thinly, constantly, and uniformly coated. As for the dipping method, the coating solution penetrates the product to perform coating, unlike coating of only the surface. The dipping method has a merit in that the physical properties of the surface are improved, and is preferably applied when the coating thickness does not need to be precisely controlled or when the surface is irregular. In the dipping method, the compositional ratio of the coating agent and the amount of the coating agent that penetrates the product must be considered, and the body is dipped in the coating solution for a predetermined amount of time, passes through several conveyor belts, and is subjected to a surface-drying process.

Meanwhile, when the humectant is not added during molding of the body but is used to coat the molded body, it is typically preferable to apply the coating layer on the humectant layer.

The method of manufacturing a pet food according to the embodiment of the present invention may include providing 100 wt % of a mixture including 30 to 70 wt % of starch, 5 to 30 wt % of sugar, and the balance of solvent mixed therein, and molding the mixture into a molded article such as the pet food of claim 1.

The molding step may include an injection-molding process for injecting the mixture constituting the body into a mold to mold the mixture into the body having a predetermined shape, and those skilled in the art may select an appropriate molding process as required.

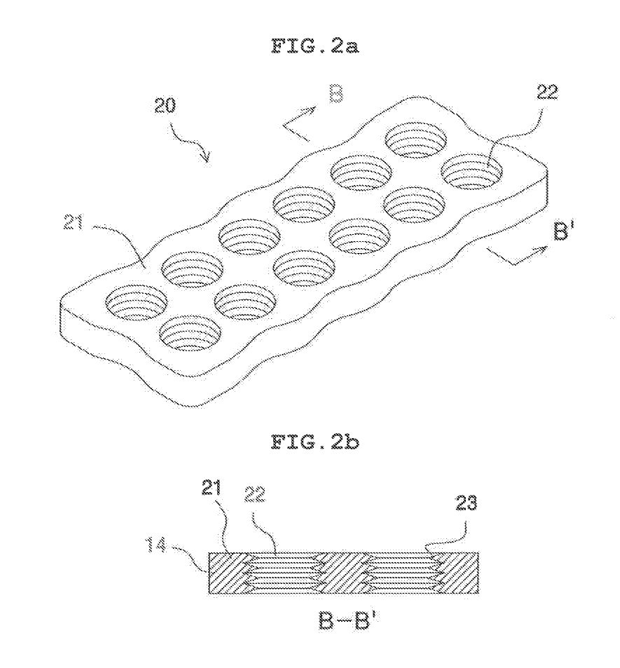

Hereinafter, a description of constitutions the same as those shown in FIG. 1a will be omitted. Further, for example, from FIGS. 2a to 5, it can be seen that a screw thread, the coating layer, and the humectant layer are omitted to thus further clarify the drawings.

FIG. 2a is a view showing a pet food 20 according to another embodiment of the present invention. Through-holes 22 in the pet food 20 are formed in the same arrangement as the through-holes 12 of FIG. 1a, that is, in a 2×6 row arrangement. However, the through-holes 22 are different from the through-holes 12 of FIG. 1a in that protrusion units 23 protrude from the inner circumferential surfaces of the through-holes 22.

Preferably, the protrusion units 23 protruding from the inner circumferential surface transversely form screw threads in the body 21 of the pet food; in other words, a plurality of protrusion units is formed to be arranged parallel to each other in the depth direction of the body, so that the protrusion units 23 easily come into physical contact with the teeth when a pet's teeth are inserted into the through-holes, and so that the protrusion units 23 are sequentially broken when a contact pressure equal to or greater than a predetermined value is applied by the teeth or the gums. This constitution is shown in greater detail in FIG. 2b, and FIG. 2b shows the protrusion unit 23 having a triangular section. However, the sectional shape of the protrusion unit may be a trapezoid (not shown in the drawing) so as to more easily perform scaling using surface contact with the teeth and to more easily remove the dental calculus and plaque.

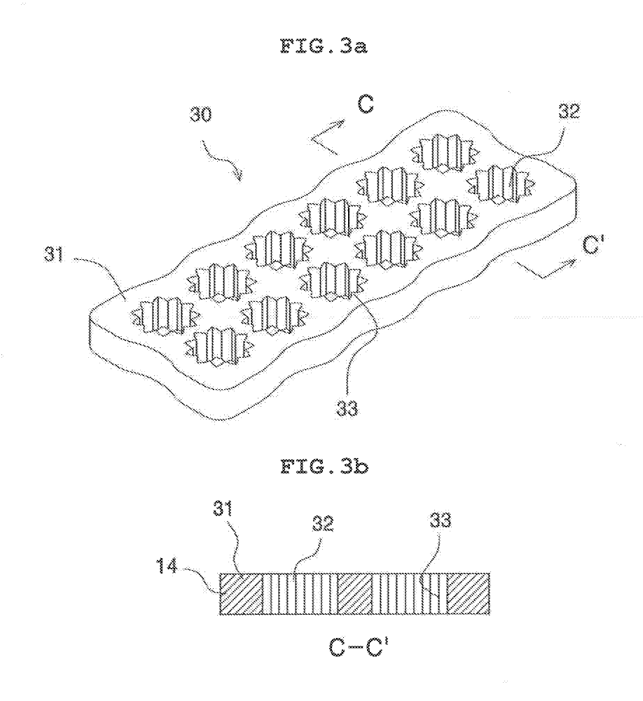

FIG. 3a shows another embodiment in which protrusions are longitudinally extended in a through-hole 32, unlike the constitution including the protrusion units 23 arranged parallel to each other in the depth direction of the body in FIG. 2a. The through-hole 32 in the body 31 has the sectional shape of a cogwheel, and the teeth of the cogwheel may correspond to protrusion units 33 that come into contact with the pet's teeth to thus remove the dental calculus and the plaque. The protrusion unit 33 may protrude from the inner circumferential surface of the through-hole 32 to easily remove the dental calculus and the plaque from the left and right sides as well as the front and rear sides of the tooth, that is, the entire outer circumferential surface of the tooth, when the tooth is inserted.

In FIG. 4a, the sectional shape of the through-hole 42 is a rectangle, and the through-holes are formed in a 2×6 row arrangement. Four protrusion units 43 protrude toward the longitudinal central axis of the through-hole from the inner circumferential surface of each through-hole 42 having the rectangular section. In FIG. 4b, the sectional shape of the through-hole 42 is a circle, and the through-holes are formed in a 2×6 row arrangement. The five protrusion units 43 protrude toward the longitudinal central axis of the through-hole from the inner circumferential surface of each through-hole 42, which has a circular section. The small-diameter through-hole 14, which is smaller than the through-hole 42, is formed between the rows of the through-holes so as to increase the possibility of insertion of small teeth or canine teeth of the pet. FIG. 4c shows the same constitution as the pet food of FIG. 4b, but is different from FIG. 4b in that a 3×6 row constitution is adopted in FIG. 4c. FIG. 4d is a plan view showing the pet food including through-holes having various sectional shapes, and shows that even through-holes having two or more different sectional shapes may be formed through the body of the food.

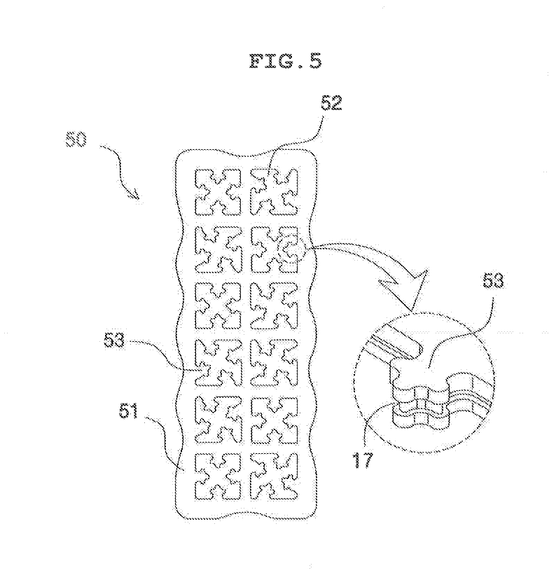

In FIG. 5, the sectional shape of the through-hole 42 is a rectangle, and the through-holes are formed in a 2×6 row arrangement. The four protrusion units 43 protrude toward the longitudinal central axis of the through-hole from the inner circumferential surface of each through-hole 42, having a rectangular section, or protrude from the inner circumferential surface so as to form a helical ridge. The sectional shape of the protrusion unit is approximately the same as the leaves of a three-leaf clover. FIG. 5 shows a perspective view in which the constitution of a groove 17 formed in the protrusion unit is partially enlarged so as to easily understand the constitution of the protrusion unit. The protrusion unit may have various other sectional shapes, if necessary, in order to increase the performance of removal of dental calculus and plaque covering the pet's teeth, and the number of grooves 17 may be selected in order to improve the efficiency with which dental calculus and plaque are removed.

A better understanding of the present invention may be obtained through the following examples which are set forth to illustrate, but are not to be construed to limit the present invention.

### EXAMPLE

5 wt % of chicken meal and 0.3 wt % of a concentrated chicken flavoring agent were added to 40 wt % of tapioca and rice starch, 5 wt % of gelatin, 3 wt % of glycerin, 8 wt % of maltitol, 5 wt % of fructo-oligosaccharides, and 1.5 wt % of soybean oil, purified water was added as a balance so that the total content was 100 wt%, and all of them were mixed, cooked, and subjected to injection molding, thereby obtaining a body 50 (molded article) such as the body of the pet food shown in FIG. 5. The body 50 had the following size. The dimensions of the exterior of the body 50 were 90×25×25 mm, and the hardness value was 40 A when measured using a duronieter.

### Comparative Example 1

The same body as in the Example was used as a typical molded pet food bar, except that through-holes were not formed through the body.

### Comparative Example 2

The same body as in Comparative Example 1 was manufactured using an elastomer material, and the through-holes formed through a portion of the body were filled with the food.

—Selection of Target Pet—

Among 60-month-old beagle pet dogs, 30 beagles were selected as pet animals to be tested. The selected pet dogs were observed to have a lot of plaque when subjected to inspection and exploration, performed for the purpose of the intra-oral test evaluation.

—Test Condition—

In order to perform the test evaluation, a total of 30 head of animals to be tested were divided into three groups each including 10 head of animals. A predetermined amount of artificial food was fed to the animals to be tested for four weeks in the morning and at night while the animals were appropriately exercised in the same space, which was well-lighted and well-ventilated. During subsequent testing, the same amount of artificial food was also supplied, and the animals were appropriately exercised.

—Test and Evaluation Procedure—

For evaluation, a disclosing solution or tablet test and a modified Snyder test using a Cariostat for a dental caries activity test were performed, and the evaluation procedure was as follows.

(1) Disclosing Solution or Tablet Test

The animals to be tested were allocated to the Example of the present invention (‘first group’), Comparative Example 1 (‘second group’), and Comparative Example 2 (‘third group’). One pet food was fed to one head of animal in the morning and the afternoon every day for eight weeks, tooth surfaces were discolored using a disclosing agent once every two weeks, and discoloring was repeated four times (two months) to check whether or not bacterial plaque covered the tooth surface and also to check changes in the amount of plaque. The discoloration results were compared using a tooth-surface plaque index measurement method.

(2) Modified Snyder Test Using Cariostat

A typical modified Snyder test is performed to check the amount and the activity of acid-forming bacteria in the oral cavity. Based on the fact that bacteria contained in tooth surface plaque or saliva form acids, the degree of activity of the acid-forming bacteria contained in saliva was measured using a colorimetric method.

The narrow surfaces of molar teeth of the upper and lower jaws of the animals to be tested were scraped once every two weeks, and scraping was repeated four times (two months) to collect the tooth surface plaque. The collected tampon was added to a prepared medium, a stopper was put thereon, and the medium was left in an incubator at 37° C. for 48 hours to perform culturing, thus comparing and evaluating changes in the color of the medium.

The resultant values that were compared and evaluated according to the aforementioned evaluation procedure were averaged, and the average values are set forth in the following Table.

TABLE 1

| | | Comparative | Comparative |
|---|---|---|---|
| State | Example | Example 1 | Example 2 |
| Plaque forming state¹⁾ | Favorable | Normal | Poor |
| Acid-forming bacteria | Inactive or | Normally or | Highly or |
| forming state²⁾ | slightly active | slightly active | normally active |

¹⁾The evaluation standard of the tooth-surface plaque index was as follows: Favorable 0~1, normal 1~2, poor 2~3, and very poor 3~5
²⁾The evaluation standard of the acid-forming bacteria is described in the following Table 2.

TABLE 2

| Color | Evaluation | Symbol |
|---|---|---|
| Blue | Inactive | − |
| Green | Slightly active | + |
| Yellow green | Normally active | ++ |
| Yellow | Highly active | +++ |

First, in the case of the test for Comparative Example 2, the body structure included an elastomer as a basic material, and spices were added to the body or the through-holes were filled with foods in order to mask a rubber odor and to increase the palatability, but the animals did not understand that the body was a food source, but merely understood that the body was a toy.

As for the disclosing solution or tablet test and the modified Snyder test using the Cariostat, in the Example, the formed through-holes were slightly smaller than the teeth of the beagle pet dogs in diameter to thus provide high frictional force to the teeth, thereby ensuring excellent plaque removal efficiency using a masticatory action that dogs are readily capable of. However, the flat type of Comparative Example 1 and Comparative Example 2 exhibited low plaque removal efficiency using antimicrobial substances contained in the material of the body, and moreover did not exhibit any plaque removal efficiency using the masticatory action.

Therefore, in order to remove the plaque and perform sealing, it is most preferable for the through-hole formed through the body to be small enough to receive the teeth of the animals slightly tightly and for the surface hardness to be about 15 to 50 A so as to maintain firmness.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### DESCRIPTION OF THE REFERENCE NUMERALS IN THE DRAWINGS

10, 20, 30, 40, 50: Pet food

11, 21, 31, 41, 51: Body

12, 22, 32, 42, 52: Through-hole

13, 23, 33, 43, 53: Protrusion unit

14: Small-diameter through-hole

15: Humectant layer

16: Coating layer

17: Groove formed in lateral surface of protrusion unit

1. A pet food capable of removing dental calculus and plaque, the pet food comprising:
a bar-type body through which at least one through-hole is transversely formed to be arranged along a longitudinal direction of the body,
wherein a tooth trunk of a pet enters the through-hole during a masticatory action of the pet to come into contact with an inner circumferential surface of the through-hole.

2. The pet food of claim 1, wherein the through-hole includes one or more protrusion units which protrude toward a longitudinal central axis of the through-hole from the inner circumferential surface of the through-hole, or which protrude from the inner circumferential surface of the through-hole so as to form a helical ridge.

3. The pet food of claim 1, wherein a screw thread is longitudinally or transversely formed in the inner circumferential surface of the through-hole.

4. The pet food of claim 2, wherein a screw thread is longitudinally or transversely formed in the inner circumferential surface of the through-hole and in lateral surfaces of the protrusion units extending from the inner circumferential surface.

5. The pet food of claim 2, wherein the through-hole including the protrusion units has a sectional shape of a circle, a polygon, or leaves of a three-leaf clover.

6. The pet food of claim 1, wherein a total area of sections of the through-holes formed through the body is more than 40% of a total surface area of an entire upper surface and an entire lower surface of the body.

7. The pet food of claim 6, wherein the through-hole has a sectional shape of a circle, a semi-circle, an oval, a polygon, a pentagram, a cogwheel, a dumbbell, or a cloud including two or more circles or ovals that partially overlap.

8. The pet food of claim 7, wherein the through-holes formed through a body have an identical sectional shape or different sectional shapes.

9. The pet food of claim 1, wherein the body includes a coating layer having a surface strength that is equal to or higher than a strength of the body.

10. The pet food of claim 9, wherein the body includes a humectant layer disposed beneath the coating layer.

11. The pet food of claim 1, wherein one or more rows of the through-holes are longitudinally and transversely arranged in the body.

12. The pet food of claim wherein a small-diameter through-hole, smaller than the through-hole, is formed between the rows of the through-holes.

13. A method of manufacturing a pet food, the method comprising:
providing 100 wt % of a mixture including 30 to 70 wt % of a starch, 5 to 30 wt % of a sugar, and a balance of solvent mixed therein; and
molding the mixture so that the mixture has a bar-type body through which at least one through-hole is transversely formed to be arranged along a longitudinal direction of the body, and so that a tooth trunk of a pet enters the through-hole during a masticatory action of the pet to come into contact with an inner circumferential surface of the through-hole.

14. The method of claim 13, further comprising:
longitudinally or transversely forming a screw thread in the inner circumferential surface of the through-hole.

15. The method of claim 13, further comprising:
forming protrusion units which protrude toward a longitudinal central axis of the through-hole from the inner circumferential surface of the through-hole, or which protrude from the inner circumferential surface of the through-hole so as to form a helical ridge.

16. The method of claim 13, further comprising:
applying a coating layer, a humectant layer, or both the coating layer and the humectant layer on the body.

17. The method of claim 13, further comprising:
forming the through-holes having a same sectional shape or two or more different sectional shapes through the body.

18. The method of claim 13, wherein the molding the mixture includes an injection-molding process.

19. The method of claim 13, wherein a coating layer includes a palatability enhancer, an antimicrobial agent, a flavoring agent, or a coloring agent.
